(19) United States
(12) Patent Application Publication
(10) Pub. No.: US 2013/0106604 A1
(43) Pub. Date: May 2, 2013

(54) HOME APPLIANCE MONITORING SYSTEM AND METHOD

(71) Applicants: HOU-HSIEN LEE, Tu-Cheng (TW); CHANG-JUNG LEE, Tu-Cheng (TW); CHIH-PING LO, Tu-Cheng (TW)

(72) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 13/418,365

(22) Filed: Mar. 13, 2012

(30) Foreign Application Priority Data
Oct. 31, 2011 (TW) 100139557

(51) Int. Cl. G08B 21/00

(52) U.S. Cl. 340/540

(57) ABSTRACT

A home appliance monitoring system is provided. The home appliance monitoring system is configured to check the running state of each home appliance and inform the user when the running state of one or more home appliance is in fact different from preset states. A home appliance monitoring method is also provided.

### BACKGROUND

1. Technical Field

The present disclosure relates to monitoring systems, and particularly, to a home appliance monitoring system and method for monitoring whether a home appliance is running in an appropriate state.

2. Description of Related Art

People often need to check whether the home appliances are running in an appropriate state before leaving home or going to bed, for example, checking whether the television, the lights, and the washers are turned off. However, sometimes people forget to check the state of the home appliances before leaving home or going to bed, thus if there is one or more of the home appliances which have not been turned off, electricity is wasted.

### BRIEF DESCRIPTION OF THE DRAWINGS

Many aspects of the present disclosure can be better understood with reference to the following drawings. The units in the drawings are not necessarily drawn to scale, the emphasis instead being placed upon clearly illustrating the principles of the present disclosure. Moreover, in the drawings, like reference numerals designate corresponding portions throughout the several views.

FIG. 1 is a block diagram of a home appliance monitoring system in accordance with an exemplary embodiment.

FIG. 2 is a schematic diagram of the preset running state of the home appliance in the home appliance monitoring system of FIG. 1.

FIG. 3 is a schematic diagram of a prompt message generated by the home appliance monitoring system of FIG. 1.

FIG. 4 is a flowchart of a home appliance monitoring method in accordance with an exemplary embodiment.

### DETAILED DESCRIPTION

Embodiments of the present disclosure will be described with reference to the accompanying drawings.

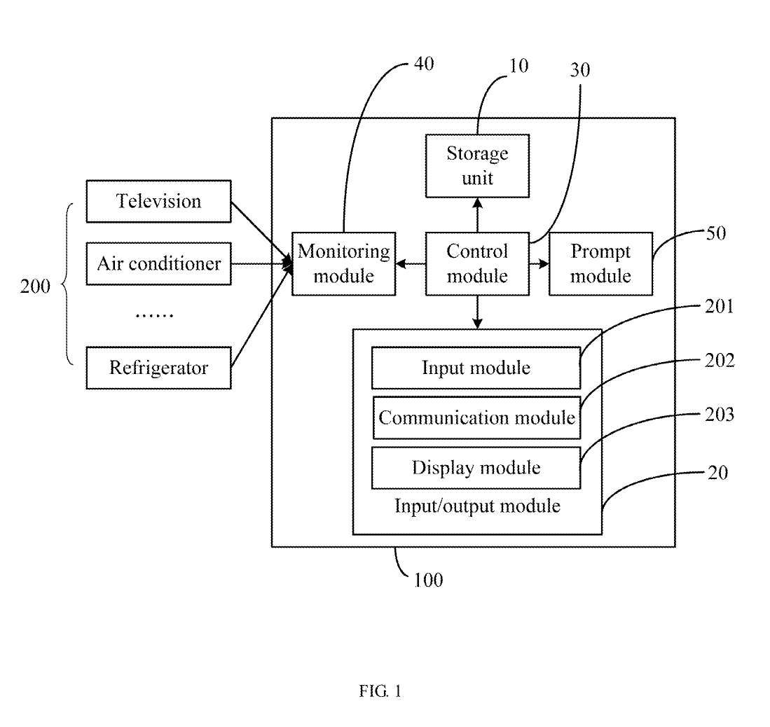

Referring to FIGS. 1-3, an embodiment of a home appliance monitoring system 100 is configured to monitoring running states of each home appliance 200 and further inform the user when the monitored running states of one or more home appliance 200 are different from preset states. Generally, the running state of each home appliance 200 includes an on state which represents that the home appliance is turned on and an off state which represents that the home appliance is turned off.

The home appliance monitoring system 100 includes a storage unit 10, an input/output module 20, a control module 30, a monitoring module 40, and a prompt module 50. The monitoring module 40 is either hardwired to the home appliance 200 or connected wirelessly and is capable of communicating with the home appliance 200.

Each home appliance 200 is designated a unique identifier. The input/output module 20 is configured to preset the running states of each home appliance 200 according to user's input and store the presets to the storage unit 10.

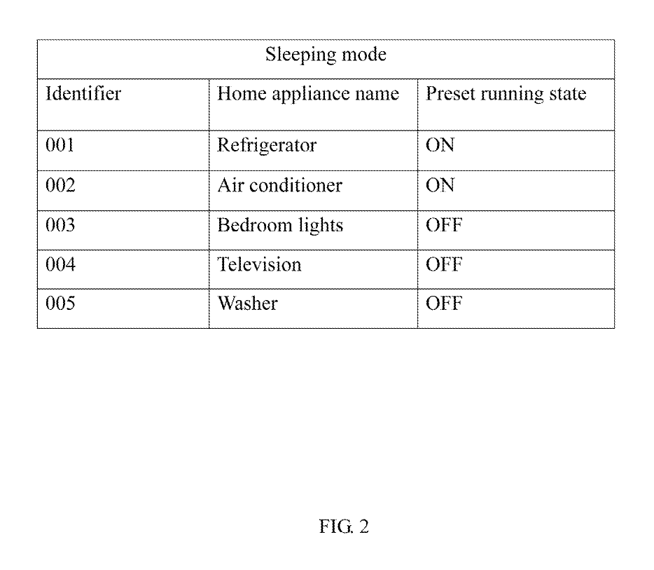

In this embodiment, the input/output module 20 is arranged in a portable electronic device, such as a cellular phone. The storage unit 10, the control module 30, the monitoring module 40, and the prompt module 50 are arranged in another electronic device, such as a server. The input/output module 20 includes an input module 201, a communication module 202, and a display module 203. The input module 201 receives user's input to preset the running state of the home appliance 200. The communication module 201 is configured to transmit the user's presets to the storage mode 10. The display module 203 can display the presets to the user, see FIG. 2.

In this embodiment, the storage unit 10 further stores a number of monitoring modes, such as a sleeping mode and a leaving mode. Generally, a sleeping mode may be used in a situation where the user is asleep, and the leaving mode may be used in a situation where no one is at home. Before presetting the running state of the home appliance, the input/output module 20 first designates a monitoring mode in response to the user's input. The running state of each home appliance 200 is preset according to the different monitoring modes. For example, as shown in FIG. 2, in the sleeping mode, the running state of the television and all the lights are preset to the off state, and the running state of the refrigerator and the air conditioner are preset to the on state; in the leaving mode, the running state of the television, the lights, the air conditioner are set to off state, the running state of the refrigerator is set to on state.

In this embodiment, the input/output module 20 responds to user's input to designate a monitoring mode and generates a command to control the monitoring module 40 to check the current running state of each of the home appliance 200.

The monitoring module 40 checks the current running state of the home appliance 200 in response to the command and sends the results to the control module 30. In this embodiment, the checking result includes the unique identifier and the current running state of each home appliance 200.

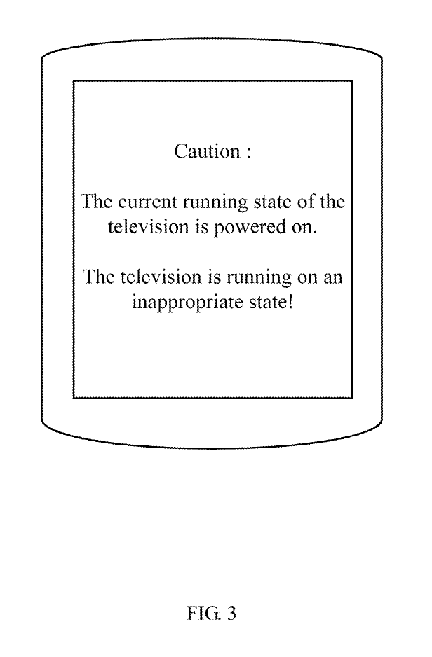

The control module 30 obtains the results of the checks and determines whether the running state of each home appliance 200 is the same as the preset running state of each home appliance 200 in the selected monitoring mode stored in the storage unit 10. If the running state of each home appliance 200 is the same as the preset running state of each home appliance 200, the control module 30 controls the prompt module 50 to generate a message to inform the user that the current running state of all the home appliance 200 are consistent with the preset running state. If the running state of one or more home appliance 200 are different from the stored preset running state, the control module 30 controls the prompt module 50 to generate a message to list the individual home appliance 200 which have a running state different from the stored preset running state, as shown in FIG. 3. For example, if a sleeping mode is designated, the preset running state of the television requires the television to be off, but the check of the running state of the television shows that it is in fact on. Then the control module 30 controls the prompt module 50 to generate a message to prompt the user that the television is running in an inappropriate state. In this embodiment, the control module 30 further transmits the message to the communication module 201 and the display module 203 displays the message to the user.

In this embodiment, the storage unit 10 further stores a safety mode configured to monitor whether the running state of one or more of the home appliance 200 changes when no one is at home. The input/output module 20 designates the safety mode and generates a command to start the safety mode in response to the user's input before or after the user leaves home. In the safety mode, the control module 30 obtains the results of a check from the checking module 40 and determines whether the running state of the home appliance 200 has changed. If it is determined that the running state of a home appliance 200 has changed, the control module 30 controls the prompt module 50 to generate a prompt or warning accordingly to the user.

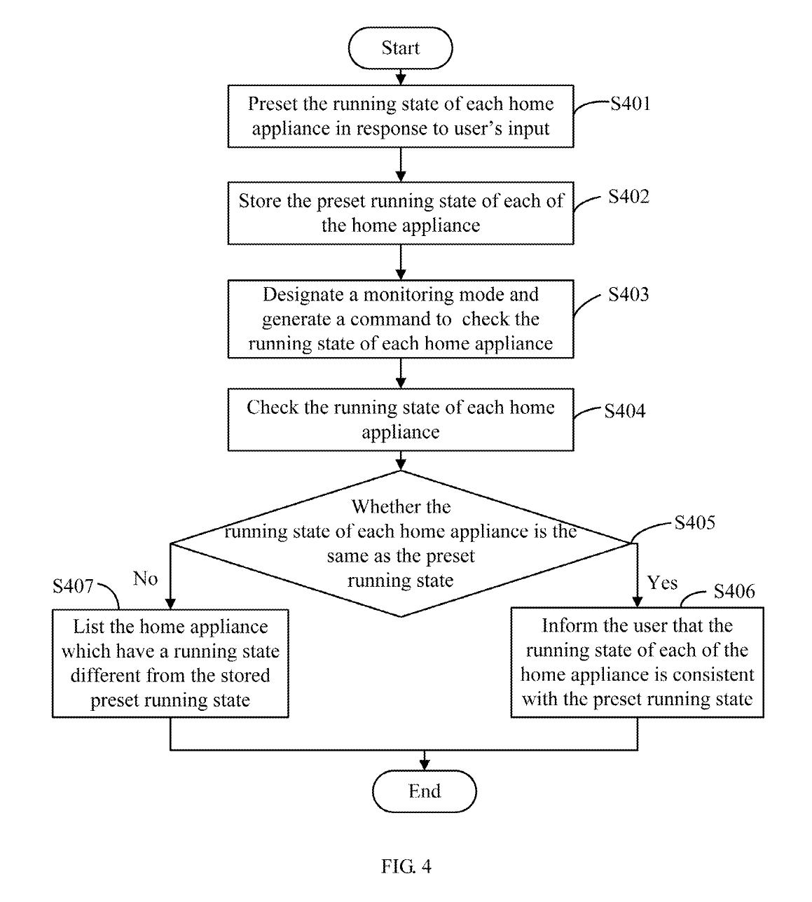

FIG. 4 is a flowchart of a home appliance checking method in accordance with an exemplary embodiment.

In step S401, the input/output module 20 designates a monitoring mode and presets the running state of each of the home appliance 200, in response to user's input.

In step S402, the input/output module 20 stores the preset running state of each of the home appliance 200 to the storage unit 10.

In step S403, the input/output module 20 designates a monitoring mode and generates a command to the monitoring module 40 to check the current running state of each of the home appliance 200 in response to the user's input.

In step S404, the monitoring module 40 checks the current running state of each home appliance 200.

In step S405, the control module 30 obtains the results of the check from the monitoring module 40 and determines whether the running state of each home appliance 200 is in fact the same as the preset running state of each home appliance 200 in the designated monitoring mode stored in the storage unit 10; if yes, the procedure goes to step S406, if not, the procedure goes to step S407.

In step S406, the control module 30 controls the prompt module 50 to generate a message to inform the user that the current running state of each of the home appliance 200 is consistent with the preset running state.

In step S407, the control module 30 controls the prompt module 50 to generate a message listing the home appliance 200 which have a running state different from the particular stored preset running state.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. A home appliance monitoring system configured to monitor running state of one or more home appliances and inform the user when the running states of some of the one or more home appliances are different from preset running states, the home appliance monitoring system comprising:
a storage unit;
an input/output module, wherein the input/output module presets a running state of each home appliance in response to a user's input and stores the preset running state to the storage unit;
a monitoring module, wherein the monitoring module communicates with each home appliance to check the current running state of the home appliance;
a control module, wherein the control module obtains a checking result and determines whether the running state of each home appliance is the same as the preset running state of each home appliance stored in the storage unit; and
a prompt module, wherein prompt module generates messages to list each of the home appliances which have a running state different from the stored preset running state according to the determination of the control module.

2. The home appliance monitoring system as described in claim 1, wherein the input/output module is arranged in a portable electronic device, the storage unit, the control module, the monitoring module, and the prompt module are arranged in another electronic device.

3. The home appliance monitoring system as described in claim 2, wherein the input/output module further comprises a input module, a communication module, and a display module, the input module presets the running state of the home appliance in response to the user's input, the communication module transmits the presets to the storage unit, and the display module displays the presets to the user.

4. The home appliance monitoring system as described in claim 1, wherein each home appliance is designated a unique identifier.

5. The home appliance monitoring system as described in claim 1, wherein the storage unit further stores a plurality of monitoring modes, before presetting the running state of the home appliance, the input/output module first designates a monitoring mode in response to the user's input.

6. The home appliance monitoring system as described in claim 5, wherein the storage unit further stores a safety mode, the input/output module designates the safety mode and generates a start command to start the safety mode in response to the user's input before the user leaving home.

7. A home appliance monitoring method applied in a home appliance monitoring system, the home appliance monitoring system capable of communicating with at least one home appliance, the method comprising:
presetting running states of the home appliance in response to user's input;
storing the preset running state of each home appliance;
generating a command to control to check the running state of each home appliance;
checking the running state of each home appliance;
obtaining the checking results and determining whether the running state of each home appliance is in fact the same as the stored preset running state of each home appliance;
generating a message to inform the user that the current running state of all the home appliance are consistent with the preset running state if determining the running state of each home appliance is the same as the stored preset running state of each home appliance; and
generating a message to list the home appliance which have a running states different from the particular stored preset running states if the checked running state of one or more home appliance are different from the stored preset running state.

8. The home appliance checking method as described in claim 7, wherein the home appliance monitoring system comprises a storage unit storing a plurality of monitoring modes, before presetting the running state of the home appliance, the method further comprises:
designating a monitoring mode in response to the user's input.
